(19) United States
(12) Patent Application Publication
(10) Pub. No.: US 2025/0128707 A1
(43) Pub. Date: Apr. 24, 2025

(54) SPRINKLING VEHICLE MANAGEMENT SYSTEM, SPRINKLING VEHICLE, AND SPRINKLING VEHICLE MANAGEMENT METHOD

(71) Applicant: Komatsu Ltd., Tokyo (JP)

(72) Inventors: Yasuyuki Yamada, Tokyo (JP); Takashi Hiranaka, Tokyo (JP); Kenta Osagawa, Tokyo (JP)

(73) Assignee: Komatsu Ltd., Tokyo (JP)

(21) Appl. No.: 18/271,051

(22) PCT Filed: Jan. 5, 2022
(86) PCT No.: PCT/JP2022/000114

§ 371 Date: Jan. 2, 2025

(30) Foreign Application Priority Data
Feb. 24, 2021 (JP) 2021-027916

(51) Int. Cl. B60W 30/14; B60P 3/22; E01H 3/02

(52) U.S. Cl. CPC B60W 30/143; E01H 3/02; B60P 3/2245; B60W 2552/15

(57) ABSTRACT

A sprinkling vehicle management system includes: a water amount data acquisition unit that acquires water amount data indicating an amount of water stored in a tank of a sprinkling vehicle for sprinkling; and a speed setting unit that sets a traveling speed of the sprinkling vehicle based on the water amount data.

### FIELD

The present disclosure relates to a sprinkling vehicle management system, a sprinkling vehicle, and a sprinkling vehicle management method.

### BACKGROUND

In order to suppress diffusion of dust or sand at a work site, there is a case where sprinkling is performed by a sprinkling vehicle. Patent Literature 1 discloses a movable fluid transporter that transports a fluid to a site.

### CITATION LIST

### Patent Literature

Patent Literature 1: JP 2013-516557 A

### SUMMARY

### Technical Problem

When the traveling speed of the sprinkling vehicle is uniformly set, the work efficiency of the sprinkling vehicle may be reduced. In order to suppress a decrease in work efficiency of a sprinkling vehicle, a technique capable of flexibly adjusting a traveling speed of the sprinkling vehicle is desired.

An object of the present disclosure is to flexibly adjust a traveling speed of a sprinkling vehicle.

### Solution to Problem

According to an aspect of the present invention, a sprinkling vehicle management system comprises: a water amount data acquisition unit that acquires water amount data indicating an amount of water stored in a tank of a sprinkling vehicle for sprinkling; and a speed setting unit that sets a traveling speed of the sprinkling vehicle based on the water amount data.

### Advantageous Effects of Invention

According to the present disclosure, the traveling speed of the sprinkling vehicle can be flexibly adjusted.

### BRIEF DESCRIPTION OF DRAWINGS

FIG. 1 is a schematic diagram illustrating an unmanned vehicle management system according to an embodiment.

FIG. 2 is a perspective view illustrating an unmanned sprinkling vehicle according to the embodiment.

FIG. 3 is a schematic diagram illustrating a work site according to the embodiment.

FIG. 4 is a functional block diagram illustrating an unmanned vehicle management system according to the embodiment.

FIG. 5 is a diagram for explaining a speed condition stored in a speed condition storage unit according to the embodiment.

FIG. 6 is a diagram for explaining travel data according to the embodiment.

FIG. 7 is a flowchart illustrating an unmanned sprinkling vehicle management method according to the embodiment.

### DESCRIPTION OF EMBODIMENTS

Hereinafter, embodiments according to the present disclosure will be described with reference to the drawings, but the present disclosure is not limited to the embodiments. The components of the embodiments described below can be appropriately combined. In addition, some components may not be used.

### [Overview of Management System]

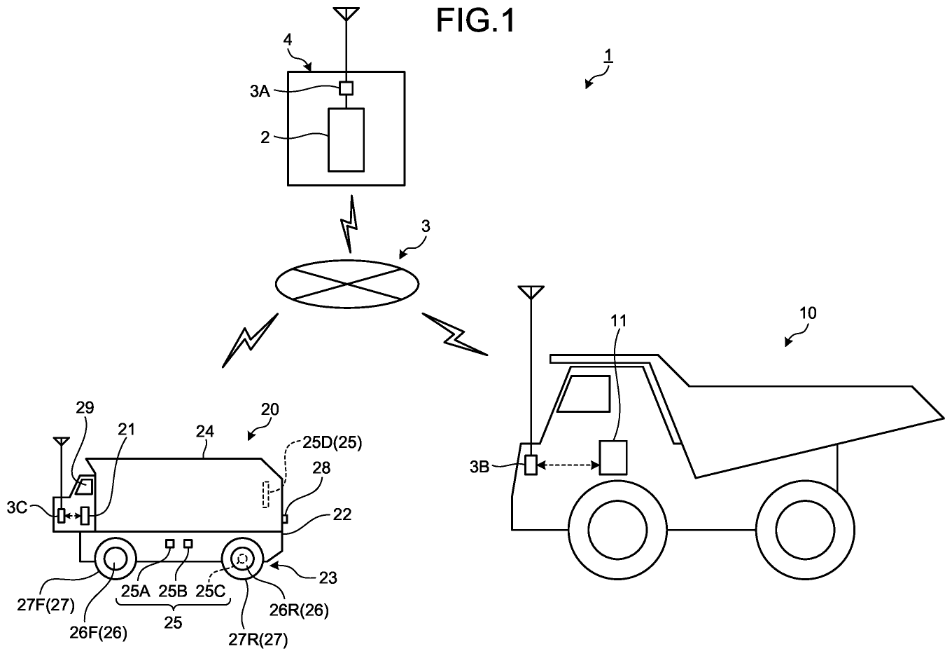

FIG. 1 is a schematic diagram illustrating an unmanned vehicle management system 1 according to an embodiment. The management system 1 manages an unmanned vehicle operating at a work site. The unmanned vehicle refers to a work vehicle that operates in an unmanned manner without depending on a driving operation by a driver. In the embodiment, the unmanned vehicle operating at the work site includes an unmanned haul vehicle 10 and an unmanned sprinkling vehicle 20.

The unmanned haul vehicle 10 travels in an unmanned manner at a work site to transport a load. An unmanned dump truck is exemplified as the unmanned haul vehicle 10. An excavated object excavated at a work site is exemplified as a load to be transported to the unmanned haul vehicle 10.

The unmanned sprinkling vehicle 20 travels in the work site in an unmanned manner and sprinkles water. An unmanned sprinkling truck is exemplified as the unmanned sprinkling vehicle 20. The unmanned sprinkling vehicle 20 sprinkles water to suppress diffusion of dust or sand at the work site.

The management system 1 includes a management device 2 and a communication system 3. The management device 2 is installed in a control facility 4 of the work site. Administrators are present in the control facility 4.

The unmanned haul vehicle 10 includes a control device 11. The unmanned sprinkling vehicle 20 includes a control device 21. The management device 2, the control device 11, and the control device 21 wirelessly communicate with each other via the communication system 3. A wireless communication device 3A is connected to the management device 2. A wireless communication device 3B is connected to the control device 11. A wireless communication device 3C is connected to the control device 21. The communication system 3 includes the wireless communication device 3A, the wireless communication device 3B, and the wireless communication device 3C.

### [Unmanned Sprinkling Vehicle]

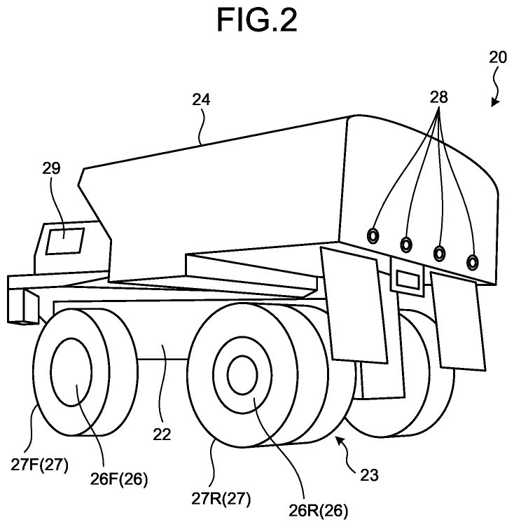

FIG. 2 is a perspective view illustrating the unmanned sprinkling vehicle 20 according to the embodiment. As illustrated in FIGS. 1 and 2, the unmanned sprinkling vehicle 20 includes the wireless communication device 3C, the control device 21, a vehicle body 22, a traveling device 23, a tank 24, a sensor system 25, and a sprinkling spray 28.

The vehicle body 22 includes a vehicle body frame. The vehicle body 22 is supported by the traveling device 23. The vehicle body 22 supports the tank 24.

In the embodiment, a cab 29 is provided in the vehicle body 22. The cab 29 is provided at a front portion of the vehicle body 22. The driver can board the cab 29 and perform a driving operation of the unmanned sprinkling vehicle 20. For example, in a case of performing maintenance or inspection of the unmanned sprinkling vehicle 20, the driver performs a driving operation of the unmanned sprinkling vehicle 20. In the embodiment, the unmanned sprinkling vehicle 20 operates in an unmanned manner at least when sprinkling water at the work site. Note that the cab 29 may not be provided in the unmanned sprinkling vehicle 20.

The traveling device 23 generates a driving force for traveling the unmanned sprinkling vehicle 20. The traveling device 23 generates a braking force for decelerating or stopping the unmanned sprinkling vehicle 20. The traveling device 23 generates a steering force for turning the unmanned sprinkling vehicle 20. The traveling device 23 moves the unmanned sprinkling vehicle 20 forward or backward. The traveling device 23 includes wheels 26. Tires 27 are mounted on the wheels 26. The wheels 26 include front wheels 26F and rear wheels 26R. The front wheels 26F are steering wheels, and the rear wheels 26R are driving wheels. Both the front wheels 26F and the rear wheels 26R may be steering wheels. Both the front wheels 26F and the rear wheels 26R may be driving wheels. The front wheels 26F may be driving wheels, and the rear wheels 26R may be steering wheels. The tires 27 include front tires 27F mounted on the front wheels 26F and rear tires 27R mounted on the rear wheels 26R. When the wheels 26 rotate in a state where the tires 27 are in contact with the road surface of the work site, the unmanned sprinkling vehicle 20 travels through the work site.

The tank 24 is a member that stores water for sprinkling. At least a part of the tank 24 is disposed above the vehicle body 22.

The sensor system 25 includes a position sensor 25A, an azimuth sensor 25B, a speed sensor 25C, and a water amount sensor 25D. The position sensor 25A detects the position of the unmanned sprinkling vehicle 20. The position of the unmanned sprinkling vehicle 20 is detected using a global navigation satellite system (GNSS). The position sensor 25A includes a GNSS receiver and detects the position of the unmanned sprinkling vehicle 20 in the global coordinate system. The azimuth sensor 25B detects the azimuth of the unmanned sprinkling vehicle 20. A gyro sensor is exemplified as the azimuth sensor 25B. The speed sensor 25C detects a traveling speed of the unmanned sprinkling vehicle 20. As the speed sensor 25C, a pulse sensor that detects the rotation of the wheel 26 is exemplified.

The water amount sensor 25D detects the amount of water stored in the tank 24. In the embodiment, the water amount sensor 25D is a weight sensor that detects the weight of water stored in the tank 24.

The amount of water stored in the tank 24 may not be directly detected by the water amount sensor 25D. The total weight of the unmanned sprinkling vehicle 20 may be detected by a weight sensor, and the amount of water stored in the tank 24 may be estimated based on the total weight of the unmanned sprinkling vehicle 20. For example, a suspension cylinder may be disposed between the wheel 26 and the vehicle body 22, and the amount of water stored in the tank 24 may be estimated on the basis of detection data of a pressure sensor that detects the pressure of the hydraulic oil in the internal space of the suspension cylinder. In this case, the pressure sensor functions as the water amount sensor 25D. That is, in the water amount sensor 25D, the total weight indicating the sum of the weight of the vehicle body 22, the weight of the tank 24, and the weight of the water stored in the tank 24 may be detected by the weight sensor, and the amount of water stored in the tank 24 may be estimated based on the change in the total weight. In this case, the weight sensor functions as the water amount sensor 25D.

The amount of water detected by the water amount sensor 25D may be a concept including the weight of water or a concept including an amount different from the weight of water. For example, the water amount sensor 25D may detect the volume of water stored in the tank 24. The water amount sensor 25D may detect a water level indicating the height of the surface of the water stored in the tank 24.

The sprinkling spray 28 sprays water in the tank 24. The sprinkling spray 28 is provided at the rear portion of the unmanned sprinkling vehicle 20. The sprinkling spray 28 sprinkles water behind the unmanned sprinkling vehicle 20. In the embodiment, a plurality of sprinkling sprays 28 is provided. The plurality of sprinkling sprays 28 is arranged at intervals in the vehicle width direction of the unmanned sprinkling vehicle 20 at the rear portion of the tank 24. The vehicle width direction refers to a direction parallel to the rotation axis of the wheels 26 when the unmanned sprinkling vehicle 20 is in a straight traveling state.

### [Work Site]

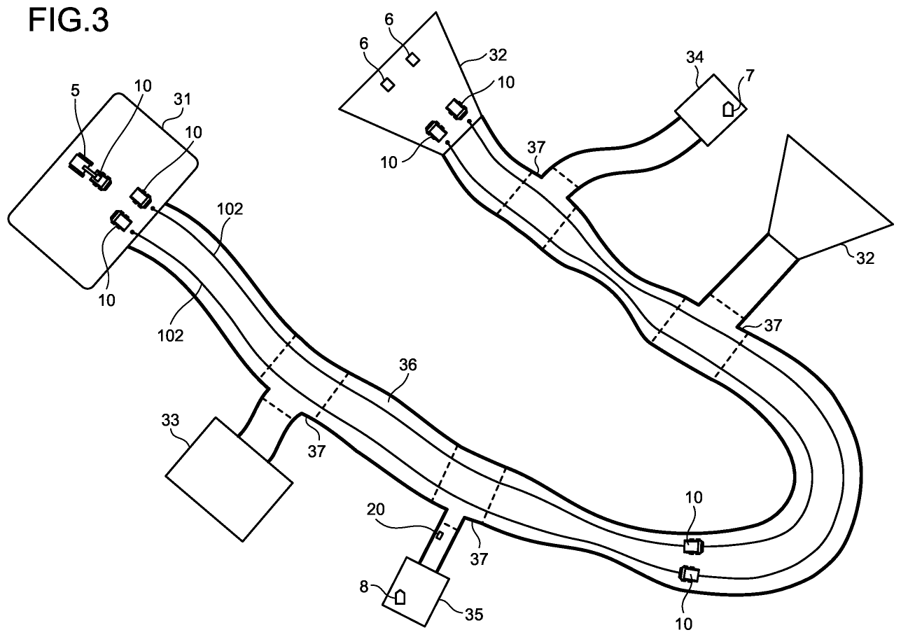

FIG. 3 is a schematic diagram illustrating a work site according to the embodiment. Examples of the work site include a mine or a quarry. The mine refers to a place or business site where minerals are mined. The quarry refers to a place or business site where stones are mined. At the work site, each of the unmanned haul vehicle 10 and the unmanned sprinkling vehicle 20 operates.

In the embodiment, the work site is a mine. Examples of the mine include a metal mine for mining metal, a non-metal mine for mining limestone, and a coal mine for mining coal.

At the work site, a loading area 31, a discharging area 32, a parking area 33, a fuel filling area 34, a water supply area 35, a travel path 36, and an intersection 37 are provided.

The loading area 31 is an area in which a loading operation of loading a load on the unmanned haul vehicle 10 is performed. In the loading area 31, a loader 5 operates. As the loader 5, an excavator is exemplified.

The discharging area 32 refers to an area where discharging work for discharging a load from the unmanned haul vehicle 10 is performed. A crusher 6 is provided in the discharging area 32.

The parking area 33 is an area where at least one of the unmanned haul vehicle 10 and the unmanned sprinkling vehicle 20 is parked.

The fuel filling area 34 is an area where at least one of the unmanned haul vehicle 10 and the unmanned sprinkling vehicle 20 is supplied with fuel. An oil feeder 7 that supplies fuel is provided in the fuel filling area 34.

The water supply area 35 is an area where the unmanned sprinkling vehicle 20 is supplied with water. In the water supply area 35, water for sprinkling is supplied to the tank 24. The water supply area 35 is provided with a water supplier 8 that supplies water to the tank 24.

The travel path 36 refers to an area where an unmanned vehicle travels toward at least one of the loading area 31, the discharging area 32, the parking area 33, the fuel filling area 34, and the water supply area 35. The travel path 36 is provided so as to connect at least the loading area 31 and the discharging area 32. In the embodiment, the travel path 36 is connected to each of the loading area 31, the discharging area 32, the parking area 33, the fuel filling area 34, and the water supply area 35.

The intersection 37 refers to an area where a plurality of travel paths 36 intersects or an area where one travel path 36 branches into a plurality of travel paths 36.

### [Management System]

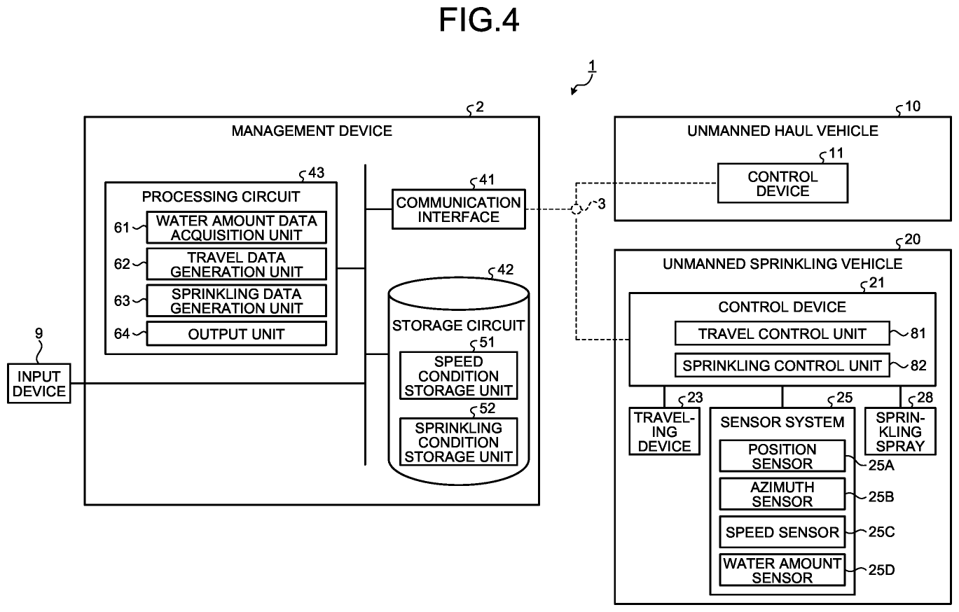

FIG. 4 is a functional block diagram illustrating the unmanned vehicle management system 1 according to the embodiment. The management system 1 includes the management device 2, the communication system 3, the control device 11, and the control device 21.

The management device 2 includes a computer system. The management device 2 is connected to an input device 9. The management device 2 includes a communication interface 41, a storage circuit 42, and a processing circuit 43.

The input device 9 is connected to the processing circuit 43. The input device 9 is operated by an administrator of the control facility 4. The input device 9 generates input data on the basis of an operation of the administrator. The input data generated by the input device 9 is input to the processing circuit 43. Examples of the input device 9 include a touch panel, a computer keyboard, a mouse, and an operation button. Note that the input device 9 may be a non-contact type input device including an optical sensor, or may be a voice input device.

The communication interface 41 is connected to the processing circuit 43. The communication interface 41 controls communication between the management device 2 and at least one of the control device 11 and the control device 21. The communication interface 41 communicates with at least one of the control device 11 and the control device 21 via the communication system 3.

The storage circuit 42 is connected to the processing circuit 43. The storage circuit 42 stores data. As the storage circuit 42, a nonvolatile memory or a volatile memory is exemplified. Examples of the nonvolatile memory include a read only memory (ROM) and a storage. Examples of the storage include a hard disk drive (HDD) and a solid state drive (SSD). As the volatile memory, a random access memory (RAM) is exemplified.

The processing circuit 43 performs arithmetic processing and control command output processing. A processor is exemplified as the processing circuit 43. Examples of the processor include a central processing unit (CPU) and a micro processing unit (MPU). A computer program is stored in the storage circuit 42. The processing circuit 43 exerts a predetermined function by acquiring and executing a computer program from the storage circuit 42.

The storage circuit 42 includes a speed condition storage unit 51 and a sprinkling condition storage unit 52.

The speed condition storage unit 51 stores a speed condition related to a target traveling speed of the unmanned sprinkling vehicle 20. The target traveling speed of the unmanned sprinkling vehicle 20 includes the upper limit speed of the unmanned sprinkling vehicle 20. The upper limit speed of the unmanned sprinkling vehicle 20 refers to an upper limit of the traveling speed of the unmanned sprinkling vehicle 20. The unmanned sprinkling vehicle 20 travels at a traveling speed not exceeding the upper limit speed at the work site.

The speed condition indicates the relationship between the amount of water stored in the tank 24 and the traveling speed of the unmanned sprinkling vehicle 20. When the sprinkling spray 28 is sprinkled, the amount of water stored in the tank 24 decreases. When water is supplied to the tank 24 in the water supply area 35, the amount of water stored in the tank 24 increases. That is, the amount of water stored in the tank 24 changes.

When the amount of water stored in the tank 24 is large, the total weight of unmanned sprinkling vehicle 20 becomes heavy. When the amount of water stored in the tank 24 is small, the total weight of the unmanned sprinkling vehicle 20 becomes light. When the unmanned sprinkling vehicle 20 having a heavy total weight and the unmanned sprinkling vehicle 20 having a light total weight travel under the same condition and brake under the same condition, the braking distance of the unmanned sprinkling vehicle 20 having a light total weight is shorter than the braking distance of the unmanned sprinkling vehicle 20 having a heavy total weight. Therefore, the unmanned sprinkling vehicle 20 having a light total weight is allowed to travel at a higher speed than the unmanned sprinkling vehicle 20 having a heavy total weight. That is, the unmanned sprinkling vehicle 20 having a small amount of water stored in the tank 24 is allowed to travel at a higher speed than the unmanned sprinkling vehicle 20 having a large amount of water stored in the tank 24.

The speed condition storage unit 51 stores a speed condition indicating a relationship between the amount of water stored in the tank 24 and the traveling speed of the unmanned sprinkling vehicle 20. In a case where the amount of water stored in the tank 24 is small, the traveling speed of the unmanned sprinkling vehicle 20 is set to a high value. In a case where the amount of water stored in the tank 24 is large, the traveling speed of the unmanned sprinkling vehicle 20 is set to a low value. The speed condition is determined in advance based on the braking distance required for the unmanned sprinkling vehicle 20.

In addition, the speed condition indicates the relationship between the inclination angle of the travel path 36 on which the unmanned sprinkling vehicle 20 travels and the traveling speed of the unmanned sprinkling vehicle 20.

In the embodiment, the inclination angle of the travel path 36 is expressed by [%]. For example, an inclination angle of lowering by 10 [m] when moving forward by 100 [m] in the horizontal direction is −10 [%]. The inclination angle of 0 [%] means that the road surface of the travel path 36 on which the unmanned sprinkling vehicle 20 travels is parallel to the horizontal plane. An inclination angle of rising by 10 [m] when moving forward by 100 [m] in the horizontal direction is +10 [%]. That is, the inclination angle of the downhill is a negative value. The inclination angle of the uphill is a positive value. The larger the absolute value of the inclination angle of the downhill is, the steeper the downhill is. The smaller the absolute value of the inclination angle of the downhill is, the gentler the downhill is.

When the unmanned sprinkling vehicle 20 travels on each of a steep downhill (downhill having a large absolute value of the inclination angle) and a gentle downhill (downhill having a small absolute value of the inclination angle) under the same condition and brakes under the same condition, the braking distance of the unmanned sprinkling vehicle 20 on the gentle downhill is shorter than the braking distance of the unmanned sprinkling vehicle 20 on the steep downhill. Therefore, the unmanned sprinkling vehicle 20 traveling on a gentle downhill is allowed to travel at a higher speed than the unmanned sprinkling vehicle 20 traveling on a steep downhill.

The speed condition storage unit 51 also stores a speed condition indicating the relationship between the inclination angle of the travel path 36 on which the unmanned sprinkling vehicle 20 travels and the traveling speed of the unmanned sprinkling vehicle 20. In the case of a gentle downhill, the traveling speed of the unmanned sprinkling vehicle 20 is set to a high value. In the case of a steep downhill, the traveling speed of the unmanned sprinkling vehicle 20 is set to a low value. The speed condition is determined in advance based on the braking distance required for the unmanned sprinkling vehicle 20.

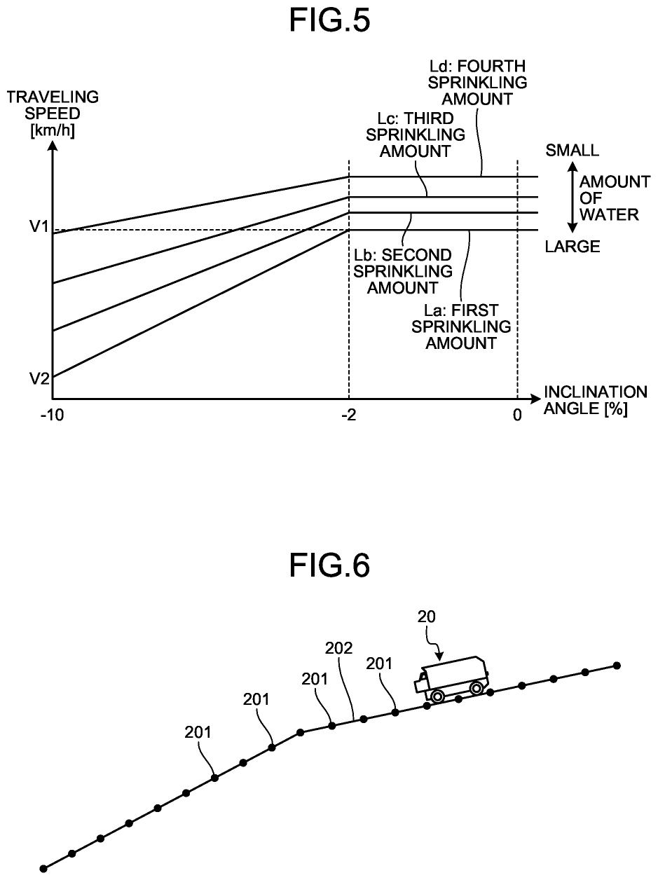

FIG. 5 is a diagram for explaining the speed condition stored in the speed condition storage unit 51 according to the embodiment. In the graph illustrated in FIG. 5, the horizontal axis represents the inclination angle [%] of the downhill where the unmanned sprinkling vehicle 20 travels, and the vertical axis represents the traveling speed [km/h] of the unmanned sprinkling vehicle 20.

In the example illustrated in FIG. 5, the speed condition storage unit 51 stores four types of speed conditions indicating the relationship between the amount of water stored in the tank 24 and the traveling speed of the unmanned sprinkling vehicle 20. In FIG. 5, the line La indicates a speed condition when the amount of water stored in the tank 24 is the first amount of water. The line Lb indicates a speed condition when the amount of water stored in the tank 24 is the second amount of water smaller than the first amount of water. The line Lc indicates a speed condition when the amount of water stored in the tank 24 is the third amount of water smaller than the second amount of water. The line Ld indicates a speed condition when the amount of water stored in the tank 24 is the fourth amount of water smaller than the third amount of water.

As illustrated in FIG. 5, the speed condition is set such that the traveling speed decreases as the amount of water stored in the tank 24 increases, and the traveling speed increases as the amount of water stored in the tank 24 decreases.

In addition, the speed condition is set such that the traveling speed decreases as the downhill on which the unmanned sprinkling vehicle 20 travels becomes steeper, and the traveling speed increases as the downhill on which the unmanned sprinkling vehicle 20 travels becomes gentler. In the example illustrated in FIG. 5, in a case where the inclination angle is −2 [%] or more, the traveling speed is constant under each of the four speed conditions. In a case where the inclination angle is less than −2 [%], the traveling speed decreases as the downhill is steeper under each of the four speed conditions.

In the example illustrated in FIG. 5, four kinds of speed conditions are stored in the speed condition storage unit 51. A plurality of speed conditions indicating the relationship between the amount of water stored in the tank 24 and the traveling speed of the unmanned sprinkling vehicle 20 is only required to be stored, and may be five or more kinds, two or three kinds. In addition, the traveling speed of the unmanned sprinkling vehicle 20 may monotonically increase as the amount of water stored in the tank 24 decreases. The amount of water stored in the tank 24 and the traveling speed of the unmanned sprinkling vehicle 20 may be in a proportional relationship.

The sprinkling condition storage unit 52 stores the sprinkling condition of the sprinkling spray 28. The sprinkling condition includes at least one of execution and stop of sprinkling from the sprinkling spray 28, a sprinkling position where the sprinkling spray 28 sprinkles at the work site, and a sprinkling amount from the sprinkling spray 28. In addition, in a case where a plurality of sprinkling sprays 28 is provided in the unmanned sprinkling vehicle 20, the sprinkling condition includes the number of sprinkling sprays 28 that execute sprinkling. In addition, in a case where the sprinkling spray 28 is installed at each of a plurality of positions of the unmanned sprinkling vehicle 20, the sprinkling condition includes an installation position of the sprinkling spray 28 that executes sprinkling. The sprinkling condition is designated by the administrator. The sprinkling condition is input to the storage circuit 42 via the input device 9. The sprinkling condition storage unit 52 stores the sprinkling condition input from the input device 9.

The sprinkling condition may be determined based on the topographical condition of the work site. For example, the sprinkling condition may be determined for each of a work site on a horizontal ground, a work site on an inclined ground, and a work site on a ground whose inclination state is unknown.

The processing circuit 43 includes a water amount data acquisition unit 61, a travel data generation unit 62, a sprinkling data generation unit 63, and an output unit 64.

The water amount data acquisition unit 61 acquires water amount data indicating the amount of water stored in the tank 24 of the unmanned sprinkling vehicle 20 for sprinkling. The amount of water stored in the tank 24 is detected by the water amount sensor 25D. Detection data of the water amount sensor 25D is transmitted to the management device 2 via the communication system 3. The detection data of the water amount sensor 25D indicates water amount data stored in the tank 24. The water amount data acquisition unit 61 acquires water amount data indicating the amount of water stored in the tank 24 from the water amount sensor 25D via the communication system 3.

The travel data generation unit 62 sets the traveling speed of the unmanned sprinkling vehicle 20 based on the water amount data acquired by the water amount data acquisition unit 61. In the embodiment, the travel data generation unit 62 functions as a speed setting unit that sets the traveling speed of the unmanned sprinkling vehicle 20 based on the water amount data stored in the tank 24 or the water amount data acquired by the water amount data acquisition unit 61. The traveling speed of the unmanned sprinkling vehicle 20 set by the travel data generation unit 62 includes an upper limit speed indicating an upper limit of the traveling speed of the unmanned sprinkling vehicle 20. The travel data generation unit 62 sets the traveling speed of the unmanned sprinkling vehicle 20 based on the water amount data acquired by the water amount data acquisition unit 61 and the speed condition stored in the speed condition storage unit 51. The travel data generation unit 62 decreases the traveling speed as the amount of water stored in the tank 24 increases, and increases the traveling speed as the amount of water stored in the tank 24 decreases.

As described above, the amount of water stored in the tank 24 changes. The water amount data acquisition unit 61 monitors water amount data that is detection data of the water amount sensor 25D. The travel data generation unit 62 updates the traveling speed of the unmanned sprinkling vehicle 20 based on the water amount data acquired by the water amount data acquisition unit 61. That is, the travel data generation unit 62 sequentially updates the traveling speed of the unmanned sprinkling vehicle 20 in accordance with a change in the amount of water stored in the tank 24.

In addition, the travel data generation unit 62 sets the traveling speed of the unmanned sprinkling vehicle 20 based on the inclination angle of the travel path 36 on which the unmanned sprinkling vehicle 20 travels. The travel data generation unit 62 sets the traveling speed of the unmanned sprinkling vehicle 20 based on, for example, the inclination angle of the downhill of the travel path 36 acquired by the survey and the speed condition stored in the speed condition storage unit 51. The travel data generation unit 62 decreases the traveling speed as the downhill of the travel path 36 on which the unmanned sprinkling vehicle 20 travels becomes steeper, and increases the traveling speed as the downhill of the travel path 36 on which the unmanned sprinkling vehicle 20 travels becomes gentler.

As illustrated in FIG. 5, for example, in a case where the amount of water detected by the water amount sensor 25D is the first amount of water and the inclination angle of the downhill is −2 [%], the travel data generation unit 62 sets the traveling speed of the unmanned sprinkling vehicle 20 to the traveling speed V1. For example, in a case where the amount of water detected by the water amount sensor 25D is the first amount of water and the inclination angle of the downhill is −10 [%], the travel data generation unit 62 sets the traveling speed of the unmanned sprinkling vehicle 20 to the traveling speed V2.

In addition, the travel data generation unit 62 generates travel data indicating a traveling condition of the unmanned sprinkling vehicle 20 including a traveling speed. In addition, the travel data generation unit 62 generates travel data indicating a traveling condition of the unmanned haul vehicle 10.

The sprinkling data generation unit 63 generates sprinkling data for controlling the sprinkling spray 28. The sprinkling data generation unit 63 generates sprinkling data for controlling the sprinkling spray 28 based on the sprinkling condition stored in the sprinkling condition storage unit 52. The sprinkling data includes at least one of execution and stop of sprinkling from the sprinkling spray 28, a sprinkling position where the sprinkling spray 28 sprinkles at the work site, and a sprinkling amount from the sprinkling spray 28. In addition, in a case where a plurality of sprinkling sprays 28 is provided, the spray data includes the number of sprinkling sprays 28 that execute spraying. In addition, in a case where the sprinkling spray 28 is installed at each of a plurality of positions of the unmanned sprinkling vehicle 20, the sprinkling data includes an installation position of the sprinkling spray 28 that executes sprinkling.

The output unit 64 transmits the travel data generated by the travel data generation unit 62 to each of the unmanned sprinkling vehicle 20 and the unmanned haul vehicle 10. As described above, the traveling speed of the unmanned sprinkling vehicle 20 is sequentially updated with the change in the amount of water stored in the tank 24. The output unit 64 transmits travel data including the updated traveling speed to the unmanned sprinkling vehicle 20.

In addition, the output unit 64 transmits the sprinkling data generated by the sprinkling data generation unit 63 to the unmanned sprinkling vehicle 20.

The output unit 64 transmits the travel data and the sprinkling data from the communication interface 41 to the control device 21 of the unmanned sprinkling vehicle 20. The output unit 64 transmits travel data from the communication interface 41 to the control device 11 of the unmanned haul vehicle 10.

The control device 11 includes a computer system. Similarly to the management device 2, the control device 11 includes a communication interface, a storage circuit, and a processing circuit. The control device 11 causes the unmanned haul vehicle 10 to travel based on the travel data transmitted from the management device 2.

The control device 21 includes a computer system. Similarly to the management device 2, the control device 21 includes a communication interface, a storage circuit, and a processing circuit. The control device 21 includes a travel control unit 81 that controls the traveling device 23 and a sprinkling control unit 82 that controls the sprinkling spray 28. The travel control unit 81 controls the traveling device 23 based on the travel data transmitted from the management device 2. The sprinkling control unit 82 controls the sprinkling spray 28 based on the sprinkling data transmitted from the management device 2.

### [Travel Data]

FIG. 6 is a diagram for explaining travel data according to the embodiment.

The travel data defines a traveling condition of the unmanned sprinkling vehicle 20. The travel data includes a course point 201, a travel course 202, a target position of the unmanned sprinkling vehicle 20, a target azimuth of the unmanned sprinkling vehicle 20, and a target traveling speed of the unmanned sprinkling vehicle 20.

A plurality of course points 201 is set at the work site. The course point 201 defines a target position of the unmanned sprinkling vehicle 20. A target azimuth and a target traveling speed of the unmanned sprinkling vehicle 20 are set for each of the plurality of course points 201. The plurality of course points 201 is set at intervals. The interval between the course points 201 is set to, for example, 1 [m] or more and 5 [m] or less. The intervals between the course points 201 may be uniform or non-uniform.

The travel course 202 refers to a virtual line indicating a target travel path of the unmanned sprinkling vehicle 20. The travel course 202 is defined by a trajectory passing through the plurality of course points 201. The unmanned sprinkling vehicle 20 travels through the work site along the travel course 202.

The target position of the unmanned sprinkling vehicle 20 refers to a target position of the unmanned sprinkling vehicle 20 when passing through the course point 201. The target position of the unmanned sprinkling vehicle 20 may be defined in a local coordinate system of the unmanned sprinkling vehicle 20 or may be defined in a global coordinate system.

The target azimuth of the unmanned sprinkling vehicle 20 refers to a target azimuth of the unmanned sprinkling vehicle 20 when passing through the course point 201.

The target traveling speed of the unmanned sprinkling vehicle 20 refers to a target traveling speed of the unmanned sprinkling vehicle 20 when passing through the course point 201.

In the embodiment, the inclination angle of the downhill of the travel path 36 on which the unmanned sprinkling vehicle 20 travels is defined by the altitude difference between the adjacent course points 201. The travel data generation unit 62 sets the target traveling speed of the unmanned sprinkling vehicle 20 based on the altitude difference between the adjacent course points 201. In the embodiment, the three-dimensional shape of the travel path 36 is acquired by a survey. The altitude of the course point 201 is defined based on a survey of the travel path 36. Note that the three-dimensional shape of the travel path 36 may be measured by a three-dimensional measurement device mounted on a flight vehicle such as a drone, and the altitude of the course point 201 may be defined on the basis of measurement data of the three-dimensional measurement device.

The travel control unit 81 controls the traveling device 23 on the basis of the travel data and the detection data of the sensor system 25. The travel control unit 81 controls the traveling device 23 so that the unmanned sprinkling vehicle 20 travels along the travel course 202 based on the detection data of the position sensor 25A and the detection data of the azimuth sensor 25B. That is, the travel control unit 81 controls the traveling device 23 so that the deviation between the detected position of the unmanned sprinkling vehicle 20 detected by the position sensor 25A when passing through the course point 201 and the target position of the unmanned sprinkling vehicle 20 set at the course point 201 becomes small. In addition, the travel control unit 81 controls the traveling device 23 so that the deviation between the detected azimuth of the unmanned sprinkling vehicle 20 detected by the azimuth sensor 25B when passing through the course point 201 and the target azimuth of the unmanned sprinkling vehicle 20 set at the course point 201 becomes small. In addition, the unmanned sprinkling vehicle 20 controls the traveling device 23 so that the unmanned sprinkling vehicle 20 travels at a traveling speed not exceeding the target traveling speed based on the detection data of the speed sensor 25C. That is, the travel control unit 81 controls the traveling device 23 so that the detected traveling speed of the unmanned sprinkling vehicle 20 detected by the speed sensor 25C when passing through the course point 201 does not exceed the target traveling speed of the unmanned sprinkling vehicle 20 set at the course point 201.

Similarly to the unmanned sprinkling vehicle 20, the unmanned haul vehicle 10 also travels based on the travel data. Similarly to the travel data of the unmanned sprinkling vehicle 20, the travel data of the unmanned haul vehicle 10 also includes a course point, a travel course 102 (see FIG. 3), a target position of the unmanned haul vehicle 10, a target azimuth of the unmanned haul vehicle 10, and a target traveling speed of the unmanned haul vehicle 10. The description of the unmanned haul vehicle 10 is omitted.

### [Unmanned Sprinkling Vehicle Management Method]

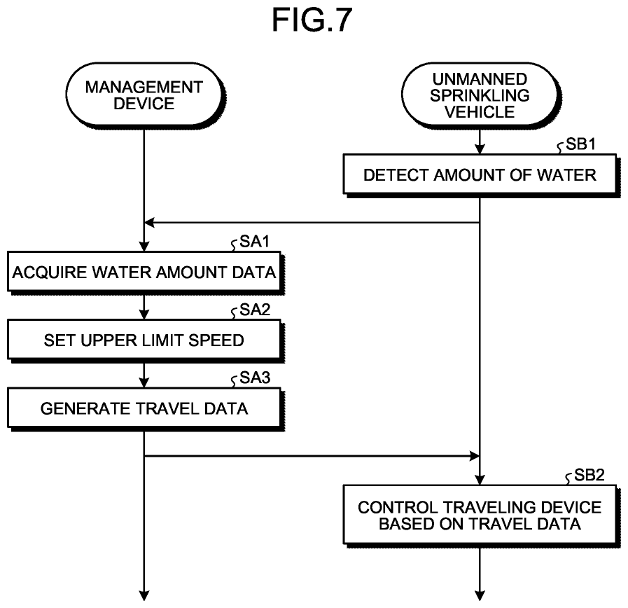

FIG. 7 is a flowchart illustrating a management method of the unmanned sprinkling vehicle 20 according to the embodiment. The unmanned sprinkling vehicle 20 travels through the work site while sprinkling water from the sprinkling spray 28. The water amount sensor 25D detects the amount of water stored in the tank 24 (Step SB1).

Detection data of the water amount sensor 25D is transmitted to the management device 2 via the communication system 3. The water amount data acquisition unit 61 acquires detection data of the water amount sensor 25D (Step SA1).

In the speed condition storage unit 51, speed conditions indicating the relationship between the amount of water stored in the tank 24 and the traveling speed of the unmanned sprinkling vehicle 20 are stored in advance. The travel data generation unit 62 sets the traveling speed of the unmanned sprinkling vehicle 20 based on the water amount data which is the detection data of the water amount sensor 25D acquired by the water amount data acquisition unit 61 and the speed condition stored in the speed condition storage unit 51 (Step SA2).

The travel data generation unit 62 generates travel data of the unmanned sprinkling vehicle 20 including the traveling speed set in Step SA2 (Step SA3).

The output unit 64 transmits the travel data generated by the travel data generation unit 62. The communication interface 41 transmits travel data to the unmanned sprinkling vehicle 20 via the communication system 3.

In addition, the output unit 64 transmits the sprinkling data generated by the sprinkling data generation unit 63. The communication interface 41 transmits the sprinkling data to the unmanned sprinkling vehicle 20 via the communication system 3.

The travel control unit 81 controls the traveling device 23 of the unmanned sprinkling vehicle 20 based on the travel data including the traveling speed transmitted from the management device 2. The travel control unit 81 controls the traveling device 23 so that the traveling speed of the unmanned sprinkling vehicle 20 does not exceed the target traveling speed set by the travel data generation unit 62.

The sprinkling control unit 82 controls the sprinkling spray 28 of the unmanned sprinkling vehicle 20 based on the sprinkling data transmitted from the management device 2.

The above-described processing is repeated. The amount of water stored in the tank 24 is reduced by sprinkling water from the sprinkling spray 28. The water amount sensor 25D detects the amount of water stored in the tank 24. Detection data of the water amount sensor 25D is sequentially transmitted to the management device 2 via the communication system 3. The water amount data acquisition unit 61 monitors water amount data that is detection data of the water amount sensor 25D. The travel data generation unit 62 sequentially updates the travel data including the target traveling speed based on the water amount data which is the detection data of the water amount sensor 25D. The travel control unit 81 acquires the updated travel data via the communication system 3. When the travel data generation unit 62 updates the travel data, the travel control unit 81 acquires the updated travel data. The travel control unit 81 acquires travel data each time the travel data is updated. The travel control unit 81 controls the traveling device 23 based on the travel data including the updated target traveling speed.

### [Effects]

As described above, according to the embodiment, the traveling speed of the unmanned sprinkling vehicle 20 is set based on the water amount data indicating the amount of water stored in the tank 24 of the unmanned sprinkling vehicle 20 for sprinkling. As a result, the traveling speed of the unmanned sprinkling vehicle 20 is flexibly adjusted. In a case where the amount of water stored in the tank 24 is small, the unmanned sprinkling vehicle 20 travels at a high speed, so that the unmanned sprinkling vehicle 20 can spray water over a wide range of the work site in a short time. Therefore, a decrease in work efficiency of the unmanned sprinkling vehicle 20 is suppressed. In a case where the amount of water stored in the tank 24 is large, the unmanned sprinkling vehicle 20 travels at a low speed, so that the braking distance of the unmanned sprinkling vehicle 20 is suppressed from becoming excessively long. The unmanned sprinkling vehicle 20 can appropriately sprinkle water to the work site.

The travel data generation unit 62 decreases the traveling speed as the amount of water stored in the tank 24 increases, and increases the traveling speed as the amount of water stored in the tank 24 decreases. As the amount of water stored in the tank 24 decreases, the traveling speed monotonously increases, so that a decrease in the work efficiency of the unmanned sprinkling vehicle 20 is suppressed. As the amount of water stored in the tank 24 increases, the traveling speed monotonously decreases, so that the braking distance of the unmanned sprinkling vehicle 20 is suppressed from becoming excessively long.

The unmanned sprinkling vehicle 20 is provided with the water amount sensor 25D that detects the amount of water stored in the tank 24. Thus, the water amount data acquisition unit 61 can constantly monitor the amount of water stored in the tank 24 based on the water amount data that is the detection data of the water amount sensor 25D.

In the speed condition storage unit 51, speed conditions indicating the relationship between the amount of water stored in the tank 24 and the traveling speed of the unmanned sprinkling vehicle 20 are stored in advance. The speed condition is determined in advance based on the braking distance required for the unmanned sprinkling vehicle 20. As a result, the travel data generation unit 62 can appropriately set the traveling speed of the unmanned sprinkling vehicle 20 based on the water amount data as the detection data of the water amount sensor 25D and the speed condition stored in the speed condition storage unit 51.

The travel data generation unit 62 decreases the traveling speed as the downhill on which the unmanned sprinkling vehicle 20 travels is steeper, and increases the traveling speed as the downhill on which the unmanned sprinkling vehicle 20 travels is gentler. By considering not only the amount of water stored in the tank 24 but also the inclination angle at which the unmanned sprinkling vehicle 20 travels, the traveling speed of the unmanned sprinkling vehicle 20 is flexibly adjusted. In a case where the downhill is gentle, the unmanned sprinkling vehicle 20 travels at a high speed, so that the unmanned sprinkling vehicle 20 can spray water over a wide range of the work site in a short time. Therefore, a decrease in work efficiency of the unmanned sprinkling vehicle 20 is suppressed. In a case where the downhill is steep, the unmanned sprinkling vehicle 20 travels at a low speed, so that the braking distance of the unmanned sprinkling vehicle 20 is suppressed from becoming excessively long. The unmanned sprinkling vehicle 20 can appropriately sprinkle water to the work site.

The travel data indicating the traveling condition of the unmanned sprinkling vehicle 20 includes the traveling speed and the travel course 202 of the unmanned sprinkling vehicle 20. As a result, the unmanned sprinkling vehicle 20 can appropriately travel the work site based on the travel data.

The amount of water stored in the tank 24 changes. By updating the travel data including the traveling speed based on the amount of water stored in the tank 24, the traveling speed of the unmanned sprinkling vehicle 20 is flexibly adjusted.

### Other Embodiments

In the above-described embodiment, the travel data generation unit 62 generates the travel data of the unmanned sprinkling vehicle 20 including the traveling speed and the travel course 202. In addition, the unmanned sprinkling vehicle 20 travels based on the travel data including the traveling speed and the travel course 202. The travel data generation unit 62 may set the traveling speed of the unmanned sprinkling vehicle 20 and may not generate the travel course 202. The unmanned sprinkling vehicle 20 is only required to travel at a traveling speed not exceeding the traveling speed set by the travel data generation unit 62.

In the above-described embodiment, at least a part of the function of the control device 11 and the function of the control device 21 may be provided in the management device 2, or at least a part of the function of the management device 2 may be provided in one or both of the control device 11 and the control device 21. For example, in the above-described embodiment, the control device 21 may have the function of the speed condition storage unit 51, the function of the water amount data acquisition unit 61, and the function of the travel data generation unit 62.

For example, when the unmanned sprinkling vehicle 20 includes the traveling device 23, the vehicle body 22 supported by the traveling device 23, and the tank 24 supported by the vehicle body 22, the control device 21 of the unmanned sprinkling vehicle 20 may set the traveling speed of the traveling device 23 based on the water amount data indicating the amount of water stored in the tank 24. In a case where the speed condition storage unit 51 described in the above embodiment is provided in the unmanned sprinkling vehicle 20, the control device 21 may set the traveling speed of the traveling device 23 based on the water amount data which is the detection data of the water amount sensor 25D and the speed condition stored in the speed condition storage unit 51. The control device 21 may decrease the traveling speed of the traveling device 23 as the amount of water stored in the tank 24 increases, and increase the traveling speed of the traveling device 23 as the amount of water stored in the tank 24 decreases. The control device 21 may decrease the traveling speed of the traveling device 23 as the downhill on which the traveling device 23 travels becomes steeper, and may increase the traveling speed of the traveling device 23 as the downhill on which the traveling device 23 travels becomes gentler. The control device 21 may update the traveling speed of the traveling device 23 based on the water amount data stored in the tank 24.

In the above-described embodiment, each of the water amount data acquisition unit 61, the travel data generation unit 62, the sprinkling data generation unit 63, and the output unit 64 may be configured by separate hardware. Each of the travel control unit 81 and the sprinkling control unit 82 may be configured by separate hardware.

### REFERENCE SIGNS LIST

1 MANAGEMENT SYSTEM
2 MANAGEMENT DEVICE
3 COMMUNICATION SYSTEM
3A WIRELESS COMMUNICATION DEVICE
3B WIRELESS COMMUNICATION DEVICE
3C WIRELESS COMMUNICATION DEVICE
4 CONTROL FACILITY
5 LOADER
6 CRUSHER
7 OIL FEEDER
8 WATER SUPPLIER
9 INPUT DEVICE
10 UNMANNED HAUL VEHICLE
11 CONTROL DEVICE
20 UNMANNED SPRINKLING VEHICLE
21 CONTROL DEVICE
22 VEHICLE BODY
23 TRAVELING DEVICE
24 TANK
25 SENSOR SYSTEM
25A POSITION SENSOR
25B AZIMUTH SENSOR
25C SPEED SENSOR
25D WATER AMOUNT SENSOR
26 WHEEL
26F FRONT WHEEL
26R REAR WHEEL
27 TIRE
27F FRONT TIRE
27R REAR TIRE
28 SPRINKLING SPRAY
29 CAB
31 LOADING AREA
32 DISCHARGING AREA
33 PARKING AREA
34 FUEL FILLING AREA
35 WATER SUPPLY AREA
36 TRAVEL PATH
37 INTERSECTION
41 COMMUNICATION INTERFACE
42 STORAGE CIRCUIT
43 PROCESSING CIRCUIT
51 SPEED CONDITION STORAGE UNIT
52 SPRINKLING CONDITION STORAGE UNIT
61 WATER AMOUNT DATA ACQUISITION UNIT
62 TRAVEL DATA GENERATION UNIT (SPEED SETTING UNIT)
63 SPRINKLING DATA GENERATION UNIT
64 OUTPUT UNIT
81 TRAVEL CONTROL UNIT
82 SPRINKLING CONTROL UNIT
102 TRAVEL COURSE
201 COURSE POINT
202 TRAVEL COURSE

1. A sprinkling vehicle management system comprising:
a water amount data acquisition unit that acquires water amount data indicating an amount of water stored in a tank of a sprinkling vehicle for sprinkling; and
a speed setting unit that sets a traveling speed of the sprinkling vehicle based on the water amount data.

2. The sprinkling vehicle management system according to claim 1,
wherein the speed setting unit decreases the traveling speed as the amount of water increases, and increases the traveling speed as the amount of water decreases.

3. The sprinkling vehicle management system according to claim 1 or 2,
wherein the sprinkling vehicle includes a water amount sensor that detects the amount of water, and
the water amount data acquisition unit acquires the water amount data from the water amount sensor.

4. The sprinkling vehicle management system according to claim 3, further comprising
a speed condition storage unit that stores a speed condition indicating a relationship between the amount of water stored in the tank and the traveling speed of the sprinkling vehicle,
wherein the speed setting unit sets the traveling speed based on the water amount data and the speed condition.

5. The sprinkling vehicle management system according to any one of claims 1 to 4,
wherein the speed setting unit decreases the traveling speed as a downhill on which the sprinkling vehicle travels is steeper, and increases the traveling speed as the downhill is gentler.

6. The sprinkling vehicle management system according to any one of claims 1 to 5,
wherein the speed setting unit generates travel data of the sprinkling vehicle including the traveling speed,
the sprinkling vehicle management system further comprising
an output unit that transmits the travel data to the sprinkling vehicle.

7. The sprinkling vehicle management system according to claim 6,
wherein the speed setting unit updates the traveling speed based on the water amount data, and
the output unit transmits the travel data including the traveling speed updated to the sprinkling vehicle.

8. A sprinkling vehicle comprising:
a traveling device;
a vehicle body supported by the traveling device;
a tank supported by the vehicle body; and
a control device that sets a traveling speed of the traveling device based on water amount data indicating an amount of water stored in the tank.

9. A sprinkling vehicle management method comprising:
setting a traveling speed of a sprinkling vehicle based on water amount data indicating an amount of water stored in a tank of the sprinkling vehicle for sprinkling; and
controlling a traveling device of the sprinkling vehicle based on the traveling speed.

10. The sprinkling vehicle management method according to claim 9,
wherein the traveling speed is decreased as the amount of water is larger, and the traveling speed is increased as the amount of water is smaller.

11. The sprinkling vehicle management method according to claim 9 or 10,
wherein the traveling speed is set based on the water amount data and a speed condition indicating a relationship between the amount of water stored in the tank and the traveling speed of the sprinkling vehicle.

12. The sprinkling vehicle management method according to any one of claims 9 to 11,
wherein the traveling speed is decreased as a downhill on which the sprinkling vehicle travels is steeper, and the traveling speed is increased as the downhill is gentler.

13. The sprinkling vehicle management method according to any one of claims 9 to 12, further comprising:
generating travel data of the sprinkling vehicle including the traveling speed; and
controlling the traveling device based on the travel data.

14. The sprinkling vehicle management method according to any one of claims 9 to 13, further comprising
updating the traveling speed based on the water amount data.
